(19) United States
(12) Patent Application Publication
(10) Pub. No.: US 2014/0207387 A1
(43) Pub. Date: Jul. 24, 2014

(54) METHOD OF ANALYZING NUMERIC MODEL FOR METAL HYDRIDE TANK

(71) Applicant: KOREA INSTITUTE OF GEOSCIENCE AND MINERAL RESOURCES, Daejeon (KR)

(72) Inventors: Sung-Wook CHO, Daejeon (KR); Han-Jung KWON, Daejeon (KR); Jeong-Hyun YOO, Suncheon-si (KR); Ji-Woong KIM, Incheon (KR); Kyung-Woo YI, Seoul (KR); Sang-Kun O, Seoul (KR)

(73) Assignee: KOREA INSTITUTE OF GEOSCIENCE AND MINERAL RESOURCES, Daejeon (KR)

(21) Appl. No.: 14/075,972

(22) Filed: Nov. 8, 2013

(30) Foreign Application Priority Data
Jan. 24, 2013 (KR) 10-2013-0008075

(51) Int. Cl. G06F 19/00

(52) U.S. Cl. CPC G06F 19/702
USPC 702/22

(57) ABSTRACT

A method of analyzing a numeric model for a metal hydride tank, which calculates the temperature change and the change of a reaction rate and the hydrogen concentration in the alloy resulting from a hydrogen reaction based on various user conditions with respect to metal hydride (MH) alloy tanks having various shapes when MH alloy tanks are actually used. The method includes (a) inputting a temperature (T), a real reaction flow rate (Q_{R}), and an initial data value of hydrogen concentration (C) for each cell of a model, (b) calculating a possible reaction rate (R_{P}) depending on the temperature (T) and the hydrogen concentration (C) in the metal hydride alloy with respect to each cell, (c) calculating a possible flow rate (Q_{P}) with respect to an entire MH alloy region, and (d) calculating a k between the real reaction flow rate (Q_{R}) and the possible reaction flow rate (Q_{P}).

### CROSS-REFERENCE TO RELATED APPLICATION

This application claims the benefit under 35 U.S.C. §119 of Korean Patent Application No. 10-2013-0008075 filed on Jan. 24, 2013 in the Korean Intellectual Property Office, the entirety of which disclosure is incorporated herein by reference.

### BACKGROUND OF THE INVENTION

1. Field of the Invention

The present invention relates to a method of analyzing a numeric model for a metal hydride tank. More particularly, the present invention relates to a method of analyzing a numeric model for a metal hydride tank, capable of calculating the temperature change and the change of a reaction rate and the hydrogen concentration in the alloy resulting from a hydrogen reaction based on various user conditions with respect to metal hydride (MH) alloy tanks having various shapes when MH alloy tanks are actually used by introducing the concept of a k (rate factor) parameter which is a ratio of a possible reaction rate in the MH alloy and a real reaction rate restricted under the control of a user.

2. Description of the Related Art

Hydrogen resources exist plentifully, can be easily transformed to different energy, and have superior advantages as a medium for energy storage, so that the hydrogen is expected as a strong energy source to be substituted for fossil fuel in the future. However, since the hydrogen exists in the phase of gas at the normal temperature and atmospheric pressure, the hydrogen represents the lower energy density per volume and an inconvenient characteristic in storage or transport.

As one of the powerful methods to solve the problem, a hydrogen storage method using metal hydride having a characteristic of representing superior volume storage density and reversibly absorbing and desorbing hydrogen around the normal temperature and the atmospheric pressure has been studied and researched. However, the speed that hydrogen is absorbed (desorbed) into metal (from the metal) is gradually slowed down due to the heat desorption (or heat absorption) followed by the reaction, so that the storage (discharge) efficiency is degraded.

Accordingly, the design for a metal hydride tank having the superior heat transfer structure is important. However, it is difficult to manufacture numerous metal hydride tanks having various shapes in an actual size and analyze the behavior thereof through the experiment under numerous and various user conditions. Accordingly, attempts to design a proper metal hydride tank through the calculation based on numeric models have been made. In particular, if the relationships between the temperature and the reaction rate of hydrogen in metal hydride is defined, so that the change of the temperature and the reaction rate of the hydrogen according to tank uses can be estimated, metal hydride tanks suitable for conditions required by a tank user may be designed. According to the conventional numeric model, with respect to a micro-region, a system grid is constructed, a heat transfer governing equation is calculated, and a reaction flow rate is calculated based on physical properties, such as equilibrium pressures and activation energy, of various materials.

However, according to the modeling based on the physical properties, such as equilibrium pressures and activation energy, of various materials, since calculation formulas and parameters required in the calculation formulas are complex, experimental errors are greatly represented, so that reliability is degraded, or a computation amount is increased. Accordingly, problems are caused in the analyzing efficiency and the practicability.

In addition, the behavior analysis applied to a microscopic scale may have a limitation in the scale of an interpretable system.

As a related art, there is Korean Unexamined Patent Publication No. 10-2011-0018310 (published on Feb. 2, 2011) disclosing a method of manufacturing an MH hydrogen storage reservoir.

### SUMMARY OF THE INVENTION

An object of the present invention is to provide a method of analyzing a numeric model for a metal hydride tank, capable of calculating the temperature change and the change of a reaction rate and the hydrogen concentration in the alloy resulting from a hydrogen reaction based on various user conditions with respect to metal hydride (MH) alloy tanks having various shapes when MH alloy tanks are actually used by introducing the concept of a k (rate factor) parameter which is the ratio of a possible reaction rate in the MH alloy and a real reaction rate restricted under the control of a user.

In order to accomplish the above object, there is provided a method of analyzing a numeric model for a metal hydride tank that includes (a) inputting a temperature (T), a real reaction flow rate (Q_{R}) restricted through user specification, and an initial data value of hydrogen concentration for each cell of a model (C) in a metal hydride alloy, (b) calculating a possible reaction rate (R_{P}) depending on the temperature (T) and the hydrogen concentration (C) in the metal hydride alloy for each cell of the model, (c) calculating a possible flow rate (Q_{P}) with respect to an entire MH alloy region of the model, (d) calculating a k (rate factor) value which is a ratio between the real reaction flow rate (Q_{R}) and the possible reaction flow rate (Q_{P}), (e) calculating a novel real reaction flow rate (Q_{R}) through Q_{R}=kQ_{P}, (f) calculating a real reaction rate (R_{R}) in each cell through R_{R}=kR_{P}, (g) calculating hydrogen concentration (C) in the MH alloy, (h) calculating change of the temperature (T) resulting from heat of reaction depending on the real reaction rate (R_{R}), and (i) repeatedly performing calculating of step (b) to step (h) according to a period and a time interval required to be required.

As described above, according to the present invention, the temperature change and the change of a reaction rate and the hydrogen concentration in the alloy resulting from a hydrogen reaction based on various user conditions with respect to metal hydride (MH) alloy tanks having various shapes when MH alloy tanks are actually used can be calculated by introducing the concept of a k (rate factor) parameter which is the ratio of a possible reaction rate in the MH alloy and a real reaction rate restricted under the control of a user.

Limitations made in various aspects such as the manufacturing cost of a device, the experimental cost of the device, and required time can be overcome.

### BRIEF DESCRIPTION OF THE DRAWINGS

FIG. 1 is a flowchart showing the computation of a method of analyzing a numeric model for a metal hydride tank according to the embodiment of the present invention.

FIG. 2 is a table showing parameters used in the method of analyzing the numeric model for the metal hydride tank.

### DETAILED DESCRIPTION OF THE INVENTION

The advantages, the features, and schemes of achieving the advantages and features of the present invention will be apparently comprehended by those skilled in the art based on the embodiments, which are detailed later in detail, together with accompanying drawings. The present invention is not limited to the following embodiments but includes various applications and modifications. The embodiments will make the disclosure of the present invention complete, and allow those skilled in the art to completely comprehend the scope of the present invention. The present invention is only defined within the scope of accompanying claims.

Hereinafter, a method of analyzing a numeric model for a metal hydride tank according to an exemplary embodiment of the present invention will be described in detail with reference to accompanying drawings.

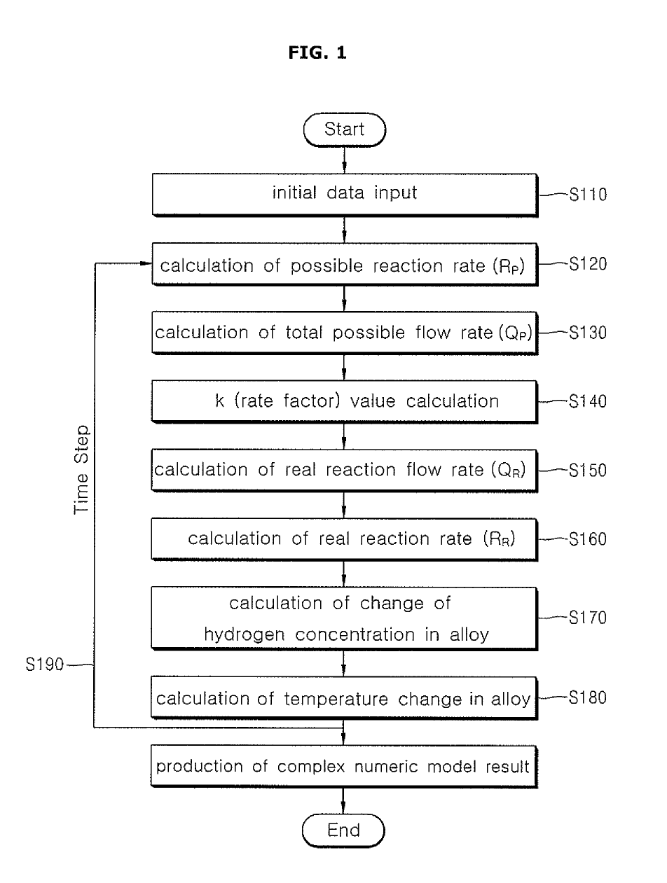

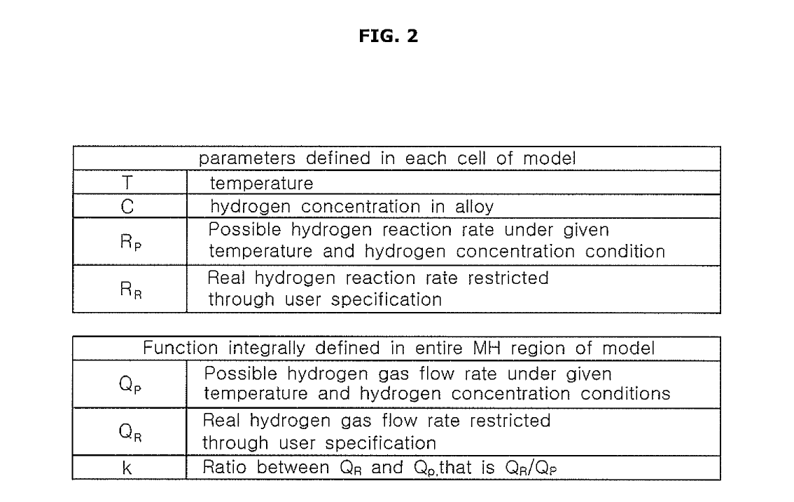

FIG. 1 is a flowchart showing the computation of a method of analyzing a numeric model for a metal hydride (MH) tank according to the embodiment of the present invention. FIG. 2 is a table showing parameters used in the method of analyzing the numeric model for the MH tank.

Referring to FIGS. 1 and 2, a method of analyzing a numeric model for a metal hydride tank according to the embodiment of the present invention includes an initial data input step (S110), a calculation step (S120) of a possible reaction rate R_{P}, an calculation step (S130) of the total possible flow rate Q_{P}, a k (rate factor) value calculation step (S140), a calculation step (5150) of a real reaction flow rate Q_{R}, a calculation step (S160) of a real reaction rate R_{R}, a calculation step (S170) of the change of hydrogen concentration in an alloy, a calculation step (S180) of the temperature change in the alloy, and a repetition calculation step (S190) according to an analyzing period and an analyzing interval.

Initial Data Input Step

In the initial data input step (S110), a temperature T, a real reaction flow rate Q_{R} restricted through user specification, and an initial data value of hydrogen concentration C in an MH alloy are input for each cell of a model. In this case, the real reaction flow rate Q_{R} is set as a reaction flow rate required by the user.

Calculation of Possible Reaction Rate R_{P}

In the calculation step S120 of the possible reaction rate R_{P}, a possible reaction rate R_{P} depending on the temperature T and the hydrogen concentration C in the MH alloy are calculated for each cell of a model. The value of the reaction rate R_{P} is calculated through following Equation 1.

R_{P}=f(T,C) Equation 1

In this case, Equation 1 is obtained through an experiment to represent that the possible reaction rate R_{P} in the alloy is determined depending on the temperature T of the alloy and the hydrogen concentration C in the alloy. In this case, if the influence exerted by the hydrogen concentration C in the alloy is negligible when the possible reaction rate R_{P} is calculated, the possible reaction rate R_{P} may be calculated as a function of only the temperature T.

Calculation of Total Flow Rate Q_{P}

In the calculation step S130 of the total possible flow rate Q_{P}, the total possible flow rate Q_{P} is calculated with respect to the entire MH alloy region of the model. In this case, the value of the total possible flow rate Q_{P} in the entire MH alloy region of the model is calculated through following Equation 2.

$${Q}_{p} = \frac{Σ ( Rp , i \times Vi )}{Σ Vi} , \qquad Equation 2$$

in which, the i represents natural numbers and each cell, and Vi represents the volume of the i-th cell.

In other words, the total possible flow rate corresponds to the sum of all possible reaction rates in each cell, and cells have difference sizes. Accordingly, Equation 2 is determined by reflecting the ratio between the sizes of the cells.

Calculation of k (Rate Factor) Value

In the k (rate factor) value calculation step S140, the k (rate factor) value which is a ratio between the real reaction flow rate Q_{R} and the possible reaction flow rate Q_{P} in the entire MH alloy region of the model is calculated. The k (rate factor) value is calculated through Equation 3.

k=Q_{R}/Q_{P} Equation 3

In other words, the value of k represents the ratio between the real reaction flow rate Q_{R} and the possible reaction flow rate Q_{P}. In this case, it should be noticed that the k value must be set to a different value based on the size of the calculated k value. The k value smaller than 1 refers to that the real reaction flow rate Q_{R} is formed lower than the possible reaction flow rate Q_{P} in the alloy due to the control of the user, and the calculated value is set as the k value. Meanwhile, if the value of the possible reaction flow rate Q_{P} is continuously reduced with the temperature change, so that the k value is equal to or greater than 1, the possible reaction flow rate is equal to or smaller than the flow rate specified by the user. In this case, the k value is set to 1, so that the real possible reaction flow rate is equal to the possible reaction flow rate, which is matched with a real phenomenon.

Calculation Step of Real Reaction Flow Rate

In the calculation step S150 of the real reaction flow rate Q_{R}, following Equation 4 is used, and the value of Q_{R} is calculated by using the k value which is newly defined in the k (rate factor) value calculation step S140 which is the last step.

Q_{R}=k×Q_{P} Equation 4

Calculation of Real Reaction Rate

In the calculation step S150 of the real reaction rate (R_{R}), the real reaction rate R_{R} in each cell is calculated. The real reaction rate R_{R} is calculated with respect to each cell by using the k value as shown in Equation 5. In the calculation step S140 of the k (rate factor) value, the k value, which is newly defined, is used.

R_{R}=k×R_{P} Equation 5

Calculation of Change of Hydrogen Concentration in Alloy

In the calculation step S170 of the change of the hydrogen concentration in the alloy, the change of the hydrogen concentration C in the MH alloy in each cell is calculated through following Equation 6-1 or 6-2.

Cᵢ₊₁=Cᵢ−R_{R}(desorption of hydrogen) Equation 6-1

Cᵢ₊₁=Cᵢ+R_{R}(absorption of hydrogen) Equation 6-2

Calculation of Temperature Change in Alloy,

In the calculation step S180 of the temperature change in the alloy, the temperature change of the MH alloy is calculated. The MH alloy makes the exothermic reaction when hydrogen is desorbed, and the MH alloy makes the endothermic reaction when the hydrogen is absorbed. In addition, since the reaction calorie per the unit quantity of reacted hydrogen is determined depending on a physical property of MH alloy material, and the real reaction rate R_{R} is equal to the reacting dose per time, the change of the temperature T can be calculated depending on the change of the heat of reaction per unit time depending on the real reaction rate R_{R}. When the numeric model is calculated, according to corresponding reaction rates, the temperature change in each cell may be calculated by designating each cell as a heat source having a negative value when hydrogen is desorbed, or a heat source having a positive value in the absorption of hydrogen.

Repetition Calculation Step Resulting from Analyzing Period and Analyzing Interval

In the repetition calculation step S190 resulting from an analyzing period and an analyzing interval, the calculation step S120 of the reaction rate R_{P}, which is possible, to the calculation step S180 of the temperature change in the alloy are repeatedly performed according to the corresponding period and the corresponding time interval required by the user for the analyzing. Accordingly, the temperature according to the time elapse, the hydrogen concentration in the MH alloy, and the change of the reaction rate can be calculated.

As described above, in the method of analyzing the numeric model for the metal hydride tank according to the embodiment of the present invention, the temperature change and the reaction rate resulting from the reaction with hydrogen can be obtained through only the computation of a numeric model for the MH alloy tank having various shapes based on the mutual relationship among three parameters of the temperature, the hydrogen concentration in the alloy, and the reaction rate.

The temperature change, the reaction rate, and the change of the hydrogen concentration in the alloy resulting from a hydrogen reaction based on various user conditions when MH alloy tanks are actually used can be more interpreted by introducing the concept of a k (rate factor) parameter which is a ratio of the possible reaction rate and the real reaction rate.

Accordingly, limitations made in various aspects such as the manufacturing cost of a device, the experimental cost of the device, and required time can be overcome.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of analyzing a numeric model for a metal hydride tank, the method comprising:
(a) inputting a temperature (T), a real reaction flow rate (Q_{R}) restricted through user specification, and an initial data value of hydrogen concentration (C) in a metal hydride alloy for each cell of a model;
(b) calculating a possible reaction rate (R_{P}) depending on the temperature (T) and the hydrogen concentration (C) in the metal hydride alloy for each cell of the model;
(c) calculating a possible reaction flow rate (Q_{P}) for the entire MH alloy region of the model;
(d) calculating a k (rate factor) value which is a ratio between the real reaction flow rate (Q_{R}) and the possible reaction flow rate (Q_{P});
(e) calculating a new real reaction flow rate (Q_{R}) through Q_{R}=kQ_{P};
(f) calculating a real reaction rate (R_{R}) in each cell through R_{R}=kR_{P};
(g) calculating hydrogen concentration (C) in the MH alloy;
(h) calculating change of the temperature (T) resulting from heat of reaction depending on the real reaction rate (R_{R}); and
(i) repeatedly performing calculating of step (b) to step (h) according to a period and a time interval required to be analyzed.

2. The method of claim 1, wherein, in step (b), the possible reaction rate (R_{P}) is calculated Equation 1,
R_{P}=f(T,C), Equation 1
in which, T represents the temperature of the MH alloy, C represents the hydrogen concentration in the MH alloy.

3. The method of claim 1, wherein, in step (c), the possible reaction flow rate (Q_{P}) is calculated through Equation 2,
$${Q}_{p} = \frac{Σ ( Rp , i \times Vi )}{Σ Vi} , \qquad Equation 2$$
in which, the i represents natural number and each cell, and Vi represents the volume of the i-th cell.

4. The method of claim 1, wherein, in step (d), the k (rate factor) value is calculated through Equation 3,
k=Q_{R}/Q_{P}, Equation 3
in which, the k value represents a ratio between the real reaction flow rate (Q_{R}) and the possible reaction flow rate (Q_{P}).

5. The method of claim 4, wherein the k value is used without change if the k value is smaller than 1, and the k value is set to 1 if the k value is equal to or greater than 1, such that the real reaction flow rate (Q_{R}) is equal to the possible reaction flow rate (Q_{P}).

6. The method of claim 1, wherein, in step (e), using the k (rate factor) value, the real reaction flow rate (Q_{R}) value is calculated through Equation 4,
Q_{R}=k×Q_{P}. Equation 4

7. The method of claim 4, wherein, in step (e), using the k (rate factor) value, the real reaction flow rate (Q_{R}) value is calculated through Equation 4,
Q_{R}=k×Q_{P}. Equation 4

8. The method of claim 1, wherein, in step (f), using the k (rate factor) value, the real reaction rate (R_{R}) value is calculated for each cell through Equation 5,
R_{R}=k×R_{P}. Equation 5

9. The method of claim 4, wherein, in step (f), using the k (rate factor) value, the real reaction rate (R_{R}) value is calculated for each cell through Equation 5,
R_{R}=k×R_{P}. Equation 5

10. The method of claim 1, wherein, in step (g), change of the hydrogen concentration in the MH alloy is calculated through Equation 6-1 or 6-2,
Cᵢ₊₁=Cᵢ−R_{R}(desorption of hydrogen),or Equation 6-1
Cᵢ₊₁=Cᵢ+R_{R}(absorption of hydrogen). Equation 6-2
